(19) United States
(12) Patent Application Publication
(10) Pub. No.: US 2014/0082413 A1
(43) Pub. Date: Mar. 20, 2014

(54) SYSTEM AND METHOD FOR USING REDUNDANCY OF CONTROLLER OPERATION

(71) Applicant: ABB TECHNOLOGY AG, Zurich (CH)

(72) Inventor: Carlos Bilich, Sandhausen (DE)

(73) Assignee: ABB TECHNOLOGY AG, Zurich (CH)

(21) Appl. No.: 14/084,023

(22) Filed: Nov. 19, 2013

Related U.S. Application Data
(63) Continuation of application No. PCT/EP2012/001712, filed on Apr. 20, 2012.

(30) Foreign Application Priority Data
May 20, 2011 (EP) 11 004 190.2

(51) Int. Cl. G06F 11/20

(52) U.S. Cl. CPC G06F 11/2028
USPC 714/12

(57) ABSTRACT

Exemplary embodiments are directed to a system and method for maintaining continuous operation applications in spite of hardware faults, maintenance, or replacement. The system having at least two physically redundant controllers, each controller being configured to achieve at least one of high availability and functional safety and having at least one control unit which actively participates in a control loop, and n redundant units that are kept synchronized in a stand-by mode. The at least two controllers are configured such that software code recorded on a first of the at least two controllers is replicated among others of the at least two controllers. Moreover, each of the at least two controllers include central processing units (CPUs) has a plurality of cores arranged within a single piece of silicon.

### RELATED APPLICATION

This application claims priority as a continuation application under 35 U.S.C. §120 to International Application PCT/EP2012/001712 filed on Apr. 20, 2012, designating the U.S. and claiming priority to European Application 11004190.2 filed on May 20, 2011 in Europe. The content of each prior application is hereby incorporated by reference in its entirety.

### FIELD

The disclosure relates to a system having at least two physically redundant controllers which is provided for applications that should be continuously operable in spite of hardware faults, maintenance or replacement achieving high availability and/or functional safety and having at least one control unit which is actively participating in the control loop and n redundant units that are kept synchronized in stand-by.

### BACKGROUND INFORMATION

Known methods for offloading the burden of tasks aimed at keeping controllers synchronized with the main processor, can involve the use of some kind of dedicated hardware like Field Programmable Gate Arrays (FPGA) or secondary processors acting as co-processing units.

This dedicated hardware is then used to execute a part or all of the software called on to keep controllers synchronized. By doing so, the load of the main processing unit is greatly reduced and the performance of the synchronization process is significantly boosted for those applications that specify frequent synchronization and lots of data per synchronization transaction, e.g., a high bandwidth.

In the context of the present disclosure a controller can include any kind of stored program control computer used for discrete automation and motion, process and power systems automation, or any other suitable method or system as desired.

Known procedures for operating said system having one active and n redundant controllers can be equipped with multi-/manycore microprocessors, and use one or a plurality of their processing cores to pump (e.g., send or transmit) information about of the state of their running software applications to their redundant neighbor's controllers. The information transmitted is used to synchronize all controllers with the active controller, so that in case the latter goes offline for any reason, for example, failure, maintenance, etc., any of the remaining controllers can seamlessly and without delay take over the execution of the software application without disruption.

At present the known hardware systems and feasible methods may not be appropriate for a reduction of the costs and keeping the power consumption down. These methods also do not make efficient use of available processing resources in the sense that the dedicated hardware is seldom used when idle.

### SUMMARY

An exemplary system for maintaining continuous operation of applications during hardware faults, maintenance, or replacement is disclosed, the system comprising: at least two physically redundant controllers, each controller being configured to achieve at least one of high availability and functional safety and having at least one control unit which actively participates in a control loop, and n redundant units that are kept synchronized in a stand-by mode, wherein the at least two controllers are configured such that software code recorded on a first of the at least two controllers is replicated among others of the at least two controllers; and each of the at least two controllers include central processing units (CPUs) having a plurality of cores arranged within a single piece of silicon.

A method for maintaining continuous operation of applications during hardware faults, maintenance, or replacement is disclosed in a system having: at least two physically redundant controllers, each controller being configured to achieve at least one of high availability and functional safety and having at least one control unit which actively participates in a control loop, and n redundant units that are kept synchronized in a stand-by mode, wherein the at least two controllers are configured such that software code recorded on a first of the at least two controllers is replicated among others of the at least two controllers; and each of the at least two controllers include central processing units (CPUs) having a plurality of cores arranged within a single piece of silicon, the method comprising: gathering, via sensors, information from at least one of equipment and processes under control (EUC), collecting, via I/O subsystems, signals output from the sensors, processing the collected signals, and transmitting the signals to a redundant logic solver, which includes controllers equipped with central processing units (CPUs) featuring a plurality of cores, executing, via the redundant logic solver, preprogrammed logic based on signals received from the I/O subsystems, and sending results back to the I/O subsystems; and driving, via the I/O subsystems and based on results received from the redundant logic solver, actuators to control the EUC.

### BRIEF DESCRIPTION OF THE DRAWINGS

Exemplary embodiments, improvements, and advantages of the present disclosure will be explained and described in more detail with respect to the following drawings:

FIG. 1 shows a schematic diagram of a redundant control system in accordance with a known implementation;

FIG. 2 shows a schematic diagram of a multi-/manycore chip in accordance with a known implementation;

FIG. 3 illustrates a schematic diagram of a microcontroller in accordance with an exemplary embodiment of the present disclosure;

FIG. 4 illustrates data flow between two dual core-based active and stand-by redundant controllers in accordance with an exemplary embodiment of the present disclosure; and

FIG. 5 illustrates a schematic diagram of an execution environment between active and standby redundant controllers in accordance with an exemplary embodiment of the present disclosure.

### DETAILED DESCRIPTION

Exemplary embodiments of the present disclosure provide an approach in which the resources of modern multi-/manycore microprocessors can be efficiently used in order to consolidate in one single processor chip all the tasks specified for keeping multiple controllers synchronized without using extra hardware but achieving comparable performance levels, e.g., not negatively affecting the performance of the main application.

Exemplary embodiments of the present disclosure provide a system whereas with the execution of the application, e.g., software and its replication is provided among the controllers. According to an exemplary embodiment of the present disclosure, the controllers can include any kind of stored program control computer used for discrete automation and motion, process and power systems automation, and any other suitable automation process and/or system as desired. The controllers can be equipped with central processing units (CPUs) featuring a plurality of cores organized within a single piece of silicon, such as multi-/manycore processors.

According to an exemplary embodiment of the disclosure known multi-/manycore processors can be used to solve a problem that currently calls for extra hardware such as co-processors, FPGA or special purpose ASICs, (application-specific integrated circuits), whereas modern processors when being used as main processors, are designed either as a multi-core processor or as a many-core processor.

In accordance with the exemplary embodiments described herein, a multi-core processor is a single component with two or more independent processors which are called “cores”. The cores can be integrated onto a single integrated circuit die, such as a chip multiprocessor or CMP, or onto multiple dies in a single chip package.

A many-core processor is a microprocessor that is similar to a multi-core processor. The many-core processor, however, is equipped with more than two cores. The design of many-core chips can be challenging largely due to issues with congestion in supplying instructions and data to the many processors.

For example, in accordance with an exemplary embodiment of the present disclosure controllers equipped with multi-/manycore processors can enable the features useful in a high performance redundant configuration without incurring in extra hardware costs.

In another exemplary embodiment, the system according to the present disclosure provides sensors which gather information from equipment and/or processes under control (EUC) as well as actuators for the execution of the information.

According to one exemplary embodiment, the system can advantageously comprise (e.g., include) I/O subsystems which are provided for collecting the signals coming from the sensors, processing the signals, and transmitting them to a redundant logic solver.

An exemplary embodiment disclosed herein provides that the I/O subsystems can be provided for receiving the signals being processed in the logic solver and transmitting them to the respective actuators.

An exemplary configuration of a control system in accordance with an exemplary embodiment of the present disclosure, has at least one sensor, but can be configured to include more than one sensor, a plurality of I/O subsystems which collect the signals coming from the sensors, and transmit the signals to a logic solver, the logic solver executes some preprogrammed logic based on the information received and sends back the results to the I/O subsystems. In turn the I/O subsystems will drive the actuators in order to perform the actions specified to control the EUC.

According to another exemplary embodiment of the present disclosure, dedicated cores of the central processing unit can be provided for the execution of synchronization related tasks, and the cores dedicated to these tasks can be regarded as “state pumps” and “state collectors” where the “states” are those of the software applications executed by the respective cores that should be redundant.

Exemplary embodiments of the present disclosure provide a system having the ability in an event that the active processing unit fails, or is taken off-line for maintenance or has to be replaced, to take over the control in negligible time through at least one other functional unit, thus assuring uninterruptible operation of the system.

An exemplary method for automating a system according to the present disclosure can include sensors, which are used to gather information from equipment and/or processes under control (EUC), I/O subsystems, which are used to collect the signals coming from the sensors, post process (signal conditioning) and transmit them to a redundant logic solver, the logic solver being composed of controllers equipped with central processing units (CPUs) featuring a plurality of cores, the logic solver being used to execute some preprogrammed logic based on the information received, and to send back the results to the I/O subsystems, which in turn will drive the actuators in order to perform the specified actions for controlling the EUC. According to an exemplary embodiment one of the processor cores, for example, Core 1, can be used for allocating time critical and/or real-time tasks, while another core, for example, core 3, can be provided for running the respective software application which extracts state information from those applications in the active controller that should be redundant, and propagate this information among the rest of controllers taking part of the redundant logic solver via a communication medium. Such medium can be any kind of computer communication data link like for example, Ethernet.

In accordance with another exemplary embodiment of the present disclosure, the controller, which is equipped with central processing units (CPUs) featuring a plurality of cores, can be used for allocating the respective cores being dedicated to the respective tasks to replicate and synchronize both applications, which include time critical as well as non-time critical applications.

In another exemplary embodiment of the present disclosure, the operation of a replica of an application can be executed on the states whereby a state monitor which is running in the second processor core of the respective stand-by controller can extract the results of the outputs and forward them back again to the active controller.

According to yet another exemplary embodiment, upon collection of the states received from the stand-by replica controller, a comparison to verify the degree of synchronization between the two controllers can be performed by the active controller.

In accordance with an exemplary embodiment disclosed herein, a controller k, which is assumed to be active, includes one set of cores being used to run virtual machines containing time critical and non-time critical applications. The virtual machines (VM) run on top of a host operating system and/or partially on the hardware using the virtualization facilities of a hypervisor which is also called a “virtual machine monitor” (VMM). The Virtual machine monitor or hypervisor is one of many virtualization techniques which allow multiple operating systems to run concurrently on a host computer. It is so named because it is conceptually one level higher than a supervisor.

In an exemplary embodiment of the present disclosure, another set of cores is used to deploy and run pump and collection software.

According to another exemplary embodiment disclosed herein, the state information from an active VM can be extracted by a VM state monitor using the services of the hypervisor whereas the state information of the active VM can be propagated by a VM state pump to its stand-by replica using for example, a shared communication medium.

In accordance with another exemplary embodiment, the state information which is broadcasted by the replicas and the active VM can be collected by a VM replica state collector and compared by a VM state comparator using this information to check the degree of synchronization between the active VM and its replicas.

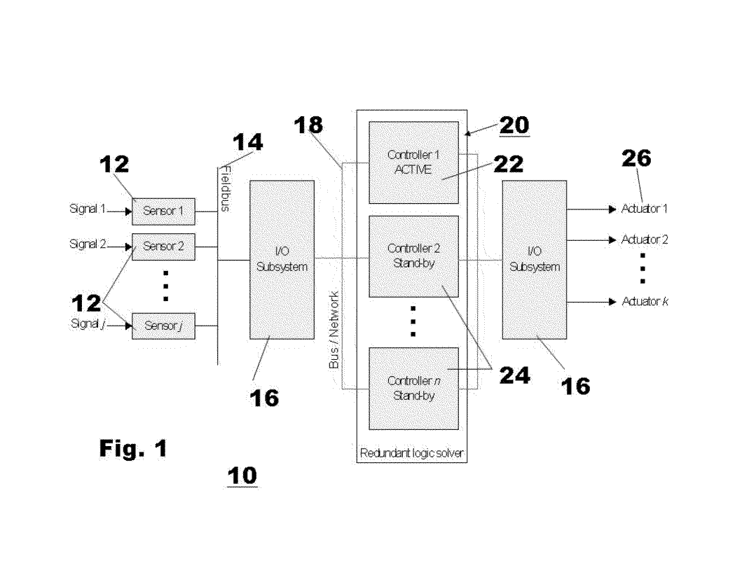

FIG. 1 shows a schematic diagram of a redundant control system in accordance with a known implementation. As shown in FIG. 1, sensors 12 can be used to gather information via fieldbus 14 from equipment and/or processes under control (EUC) (not shown). I/O subsystems 16 collect the signals coming via fieldbus 14 from the sensors 12, post process (signal conditioning) and transmit them via a bus/network 18 to the logic solver 20. The solver 20, which includes a couple of controllers 22, 24, executes some pre-programmed logic based on the information received and sends the results back to the I/O subsystems 16, which in turn will drive actuators 26 in order to perform the specified actions for controlling the EUC.

According to exemplary embodiments of the present disclosure, exemplary control systems can be provided for applications that should be continuously operable, e.g., available in spite of hardware faults, maintenance or replacement. Such systems 10 can have at least one control unit 22 which is actively participating in the control loop and n redundant units that are kept synchronized in stand-by. If the active unit 22 fails, or is taken off-line for maintenance or has to be replaced, the system 10 design can provide that there shall be at least one remaining unit 24 able to take over the control in negligible time thus assuring uninterruptible operation of the system 10.

Keeping redundant units 24 tightly synchronized with the active unit 22 can directly influence minimizing the switchover time. In the case of complex control loops with many states and short cycle times, for example, on the order of use, the solution to the problem can be challenging in terms of performance and communication bandwidth.

In such cases, known controllers can use additional hardware like FPGAs or ASICs to support the main processing unit with synchronization tasks. As already discussed, exemplary embodiments of the present disclosure use multiple cores available in known processors to support the main processing unit without using extra hardware components.

According to an exemplary embodiment described herein, the redundant logic solver can include controllers 22, 24 having central processing units (CPUs) featuring a plurality of cores organized within a single piece of silicon, also known as chip.

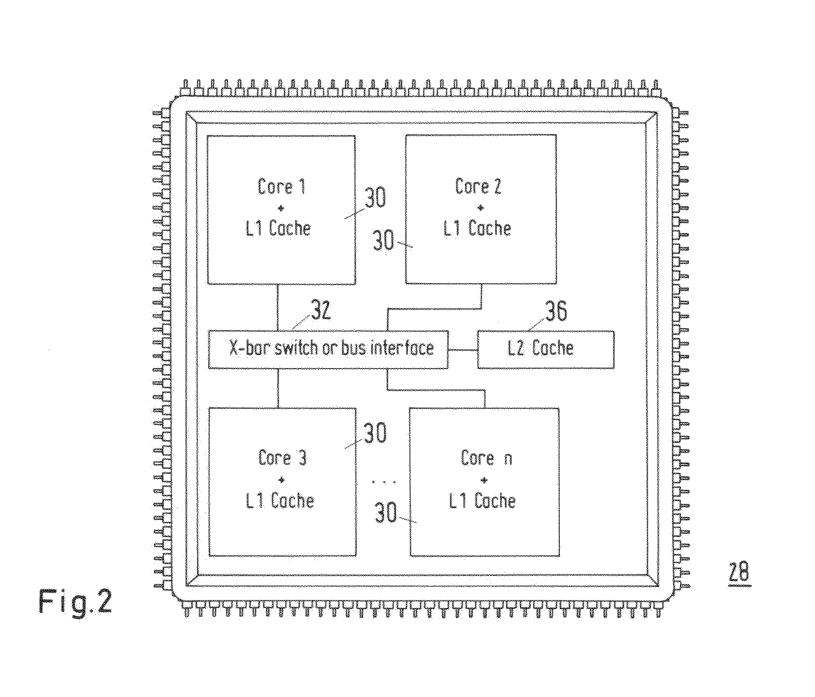

FIG. 2 shows a schematic diagram of a multi-/manycore chip in accordance with a known implementation. As shown in FIG. 2, the chip 28 includes a plurality of single cores 30 including level 1 caches as well as an X-bar switch or bus interface 32 and a level 2 cache 34.

Exemplary embodiments of the present disclosure use dedicated cores 30 to undertake synchronization related tasks. The cores 30 dedicated to these tasks can be regarded as “state pumps” and “state collectors” where the “states” are those of the software applications that should be redundant, e.g., replicated onto other physical controllers.

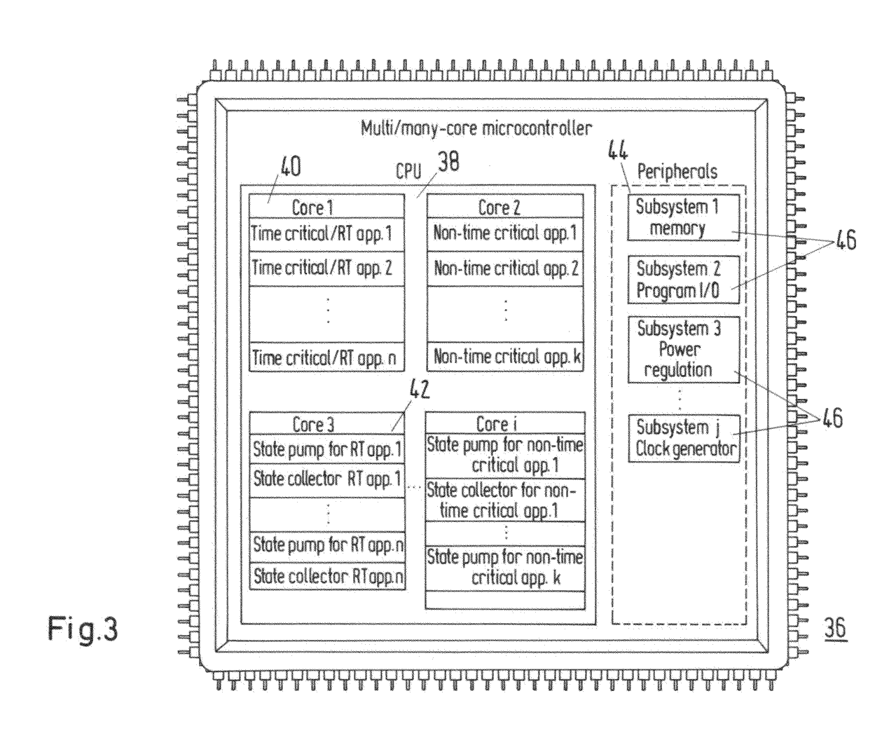

FIG. 3 illustrates a schematic diagram of a microcontroller in accordance with an exemplary embodiment of the present disclosure. As shown in FIG. 3, a multi/many-core microcontroller 36 has a central processing unit (CPU) 38 including a plurality of cores 40, 42, as well as peripherals 44, which include subsystems 46, such as memories, program I/O, power regulation, clock generator, or other suitable devices as desired.

In an exemplary embodiment, one core 40 of the processor cores, e.g., core 1, can be used to allocate time critical and real-time tasks, while another core 42, e.g., core 3, runs propagators, also denominated as pumps, and collectors.

According to an exemplary embodiment, a pump of a respective core can designate a software application that extracts state information from those applications in the active controller that should be redundant, for example, those running in core 40. The application can propagate or “pump” this information among the rest of controllers forming the redundant logic solver through a communication medium, for example, Ethernet.

A “Collector” of a respective core designates another software application that receives the information being pumped throughout the communication medium and replicates it in the corresponding core of the stand-by controller where it is running.

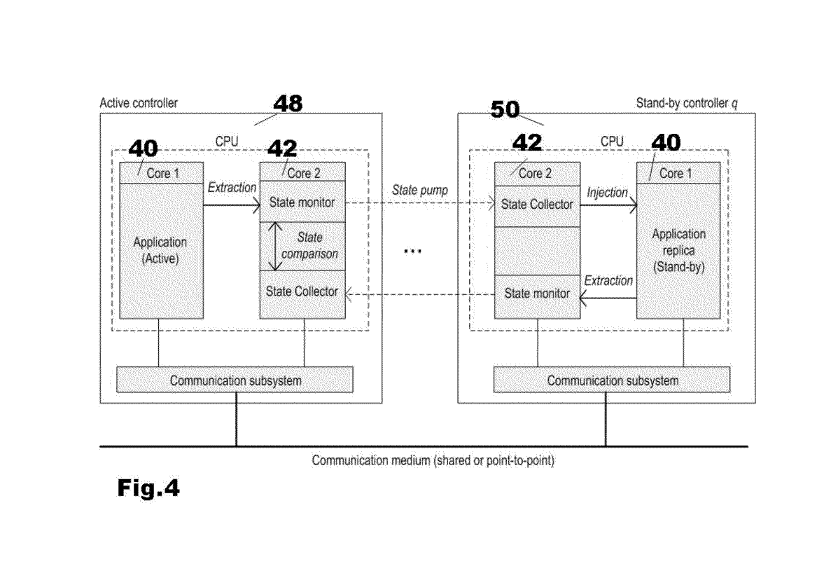

If the microprocessor chip 36 has a plurality of cores 40, 42 as shown in FIG. 3, then many cores 40, 42 can allocate “pumps” and “collectors” to replicate and synchronize both time critical as well as non-time critical applications. FIG. 4 illustrates data flow between two dual core-based active and stand-by redundant controllers in accordance with an exemplary embodiment of the present disclosure.

The replica application executes its operations on the states and a state monitor running in the second processor core of the Stand-by controller “extracts” the results of the outputs and “pumps” them back again to the active controller. Upon collection of the states received from the stand-by replica application, the active controller performs a comparison to verify the degree of synchronization between the two.

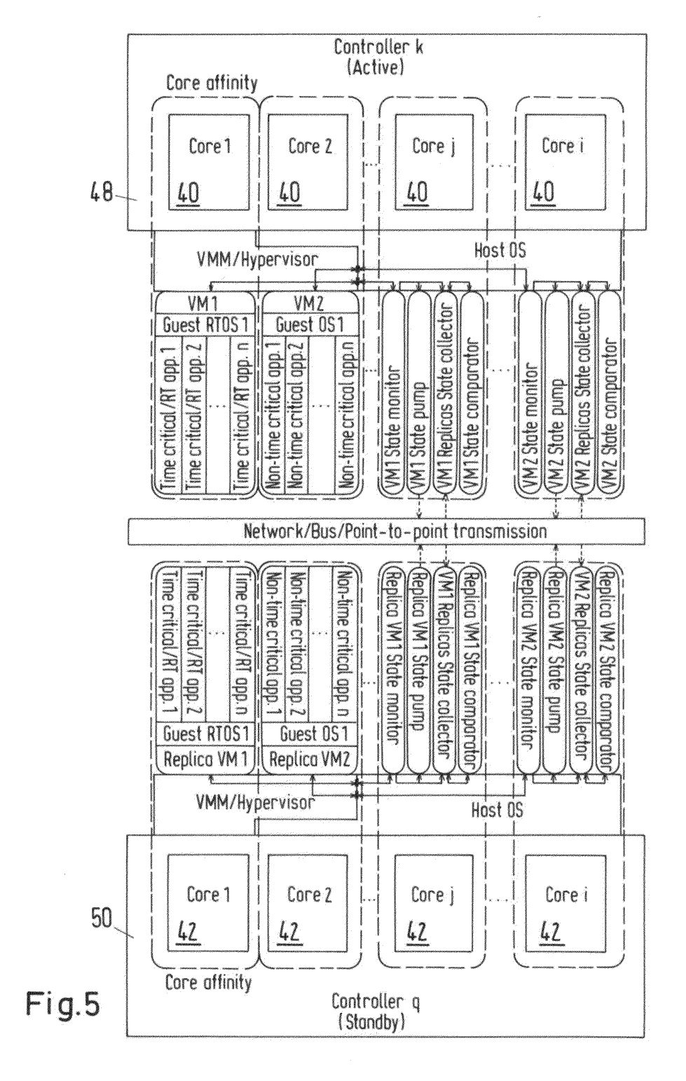

In another exemplary embodiment, the state pumps and collectors of a respective core can be used not just to replicate single applications but to replicate entire execution environments including for example, a complete virtual machine. FIG. 5 illustrates a schematic diagram of an execution environment between active and standby redundant controllers in accordance with an exemplary embodiment of the present disclosure.

As shown in FIG. 5, controller 48, assumed to be active, has one set of cores 40 that can be used to run virtual machines containing time critical and non-time critical applications. The virtual machines (VM) run on top of a Host operating system and/or partially on the hardware using the virtualization facilities of a hypervisor, also known as, Virtual Machine Monitor (VMM).

During processing, a hypervisor, also called virtual machine monitor (VMM), is one of many virtualization techniques which allow multiple operating systems, termed guests, to run concurrently on a host computer, a feature called hardware virtualization. It is so named because it is conceptually one level higher than a supervisor.

Another set of cores 42 can be used to deploy and run pump and collection software. A VM state monitor can extract state information from an active VM using the services of the VMM. A VM state pump propagates state information of the active VM to its stand-by replica application using, for example, a shared communication medium. A VM replica state collector collects state information broadcasted by the replicas and the active VM.

A VM state comparator uses this information to check the degree of synchronization between the active VM and its replicas. According to exemplary embodiments of the present disclosure, a set of applications can include a VM state monitor, a VM state pump, a VM replica state collector, and a VM state comparator, and as a result be designated as “VMator” short for VM replicator. Accordingly, a VMator is expected to run on top of the of host operating system and have affinity for one dedicated core.

Exemplary embodiments of the present disclosure provide advantages over known systems in that it makes clever use of modern multi/manycore processors to execute a process that currently calls for extra hardware such as coprocessors, FPGA, or special purpose ASICs. Exemplary controllers equipped with multi-/manycore processors can be used to implement the exemplary methods described herein and enable the features used in high performance redundant configuration without incurring extra hardware costs.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### REFERENCE LIST

10 control system
12 sensor
14 fieldbus
16 first I/O subsystem
18 bus/network
20 logic solver

### 22 Controller

24 second I/O subsystem
26 actuator
28 multi-/many-core chip
30 core incl. level one cache
32 X-bar switch or bus interface
34 level two cache
36 multi/many-core microcontroller
38 central processor unit (CPU)
40 core
42 core
44 peripherals

### 46 Subsystem

48 active controller
50 stand-by controller

What is claimed is:

1. A system for maintaining continuous operation of applications during hardware faults, maintenance, or replacement the system comprising:
at least two physically redundant controllers, each controller being configured to achieve at least one of high availability and functional safety and having at least one control unit which actively participates in a control loop, and n redundant units that are kept synchronized in a stand-by mode,
wherein the at least two controllers are configured such that software code recorded on a first of the at least two controllers is replicated among others of the at least two controllers; and
each of the at least two controllers include central processing units (CPUs) having a plurality of cores arranged within a single piece of silicon.

2. The system according to claim 1, comprising:
sensors configured to gather information from at least one of equipment and processes under control (EUC), and
actuators configured to generate a response to the gathered information.

3. The system according to claim 1, comprising:
I/O subsystems configured to collect signals output by the sensors, process the signals, and transmit the processed signals to a redundant logic solver.

4. The system according to claim 1, wherein the I/O subsystems are configured to receive the signals being processed in the logic solver and transmit the received signals to the respective actuators.

5. The system according to claim 1, comprising:
dedicated cores of the central processing unit for synchronizing related tasks.

6. The system according to claim 1, wherein one of the at least two controllers is an active unit, and in case the active unit fails, is taken off-line for maintenance, or has to be replaced, the other of the at least two controllers is configured to take over control and perform operations in place of the active unit in negligible time, thereby assuring uninterruptible operation of the system.

7. A method for maintaining continuous operation of applications during hardware faults, maintenance, or replacement in a system having: at least two physically redundant controllers, each controller being configured to achieve at least one of high availability and functional safety and having at least one control unit which actively participates in a control loop, and n redundant units that are kept synchronized in a stand-by mode, wherein the at least two controllers are configured such that software code recorded on a first of the at least two controllers is replicated among others of the at least two controllers; and each of the at least two controllers include central processing units (CPUs) having a plurality of cores arranged within a single piece of silicon, the method comprising:
gathering, via sensors, information from at least one of equipment and processes under control (EUC),
collecting, via I/O subsystems, signals output from the sensors, processing the collected signals, and transmitting the signals to a redundant logic solver, which includes controllers equipped with central processing units (CPUs) featuring a plurality of cores,
executing, via the redundant logic solver, preprogrammed logic based on signals received from the I/O subsystems, and sending results back to the I/O subsystems; and
driving, via the I/O subsystems and based on results received from the redundant logic solver, actuators to control the EUC.

8. The method according to claim 7, comprising:
allocating, via one of the plurality of cores, time critical and/or real-time tasks;
running, via another core, a respective software application which extracts state information from applications in one of the at least two controllers functioning as an active controller that are to be redundant; and
propagating the state information among other controllers taking part in the redundant logic solver via a communication medium.

9. The method according to claim 7, wherein the controller includes central processing units featuring a plurality of cores for allocating the respective cores to respective tasks for replicating and synchronizing, time critical as well as non-time critical applications.

10. The method according to claim 7, comprising:
executing operations of a replica application on states, wherein a state monitor which is running in a second processor core of the respective stand-by controller extracts results of the executed operations and forwards the results to the active controller.

11. The method according to claim 7, comprising:
upon collection of the states received from a stand-by replica application, comparing states of the replica application and original application to verify a degree of synchronization.

12. The method according to claim 7, wherein in a controller, which is assumed to be active, one set of cores is being used to run virtual machines containing time critical and non-time critical applications, and wherein virtual machines (VM) are at least one of run on top of a host operating system and partially on hardware using virtualization facilities of a hypervisor.

13. The method according to claim 7, wherein another set of cores is being used to deploy and run pump and collection software.

14. The method according to claim 7, wherein state information from an active VM is extracted by a VM state monitor using the services of the hypervisor, wherein the state information of the active VM is propagated by a VM state pump to a stand-by replica application of a controller using for example a shared communication medium.

15. The method according to claim 7, wherein state information broadcast over a communication medium by the replica applications and an active VM is collected by a VM replica state collector and compared by a VM state comparator to check a degree of synchronization between the active VM and its replicas.
